(19) United States
(12) Patent Application Publication
(10) Pub. No.: US 2017/0182427 A1
(43) Pub. Date: Jun. 29, 2017

(54) Portable Gaming System

(71) Applicant: Nathaniel White, Naperville, IL (US)

(72) Inventor: Nathaniel White, Naperville, IL (US)

(21) Appl. No.: 14/979,860

(22) Filed: Dec. 28, 2015

(51) Int. Cl. A63F 13/95; A63F 13/31; A63F 9/24

(52) U.S. Cl. CPC A63F 13/95; A63F 9/24; A63F 13/31; A63F 2009/2488; A63F 2009/2492

(57) ABSTRACT

A portable gaming system includes an electronic device. The electronic device may store data pertaining to a game. A controller is provided and the controller controls operational aspects of the game. A display is provided. A storage unit is provided and the storage unit is in selective communication with the electronic device. Thus, the storage unit receives and stores the data pertaining to the game. The storage unit is in selective communication with the controller and the display. Thus, the display displays the game thereby facilitating the game to be played when the display is in a remote location with respect to the electronic device.

### BACKGROUND OF THE DISCLOSURE

### Field of the Disclosure

The disclosure relates to gaming devices and more particularly pertains to a new gaming device for facilitating a video game to be played at a remote location with respect to a gaming console.

### SUMMARY OF THE DISCLOSURE

An embodiment of the disclosure meets the needs presented above by generally comprising an electronic device. The electronic device may store data pertaining to a game. A controller is provided and the controller controls operational aspects of the game. A display is provided. A storage unit is provided and the storage unit is in selective communication with the electronic device. Thus, the storage unit receives and stores the data pertaining to the game. The storage unit is in selective communication with the controller and the display. Thus, the display displays the game thereby facilitating the game to be played when the display is in a remote location with respect to the electronic device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a portable gaming system according to an embodiment of the disclosure.

FIG. 2 is a top perspective view of an embodiment of the disclosure.

FIG. 3 is a bottom view of an embodiment of the disclosure.

FIG. 4 is a schematic view of an embodiment of the disclosure.

### DESCRIPTION OF THE PREFERRED EMBODIMENT

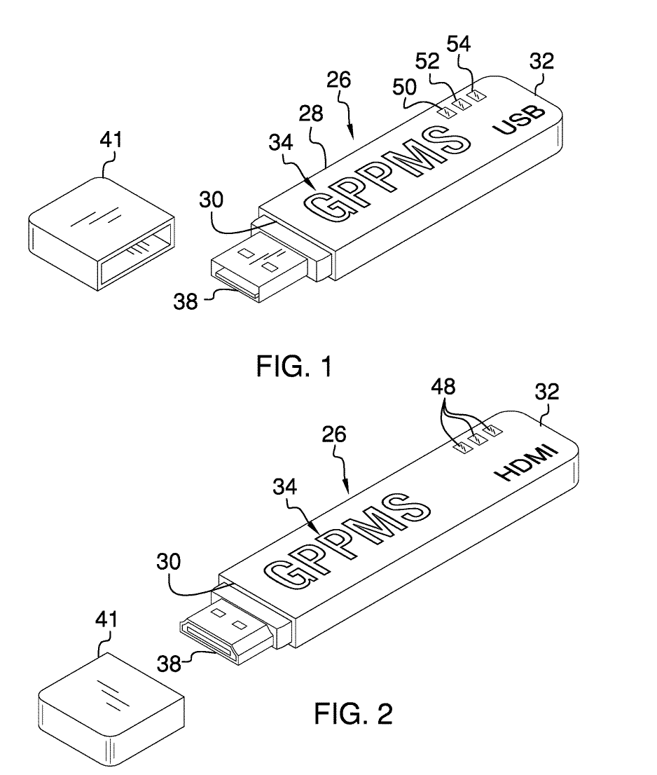

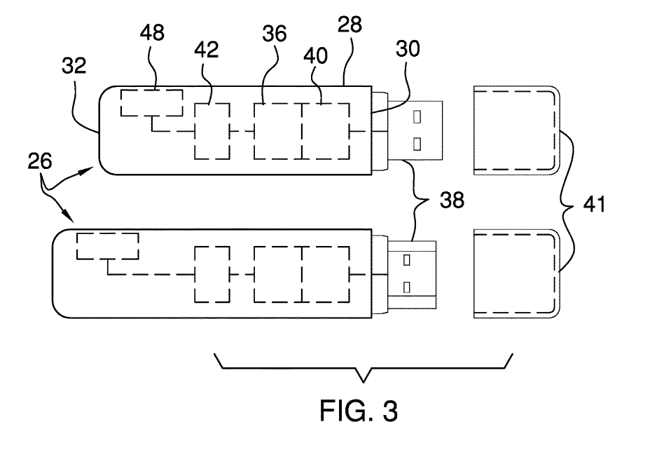

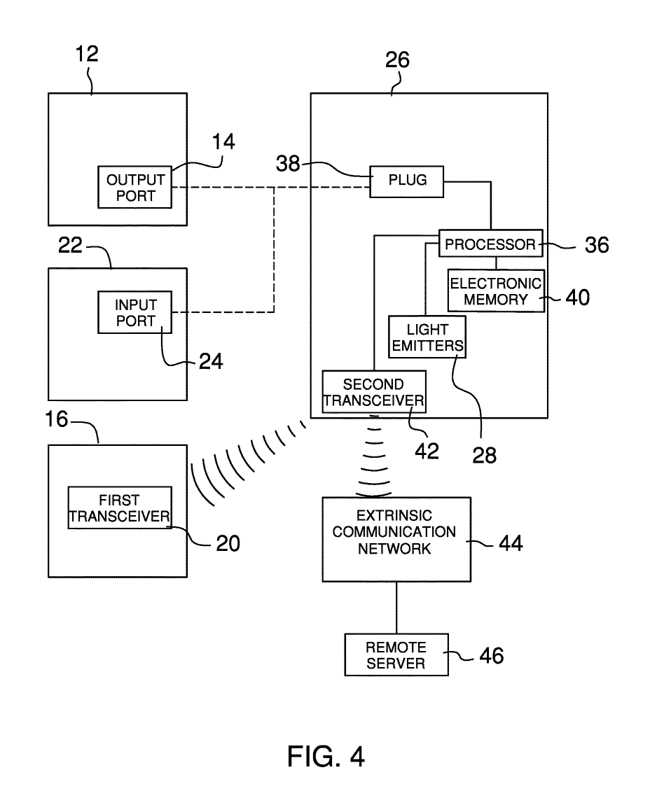

With reference now to the drawings, and in particular to FIGS. 1 through 4 thereof, a new gaming device embodying the principles and concepts of an embodiment of the disclosure and generally designated by the reference numeral 10 will be described.

As best illustrated in FIGS. 1 through 4, the portable gaming system 10 generally comprises an electronic device 12. The electronic device 12 has an output port 14 and the electronic device 12 stores data pertaining to a video game. The electronic device 12 may store the data on a hard disk drive, electronic memory or other digital data storage method. The electronic device 12 may comprise a Microsoft Xbox, a Sony Playstation or other electronic device facilitating the play of video games.

A controller 16 is provided and the controller 16 controls operational aspects of the video game. The controller 16 has a first transceiver 20 and the first transceiver 20 may comprise a radio frequency transceiver or the like. The controller 16 may comprise a Microsoft Xbox controller, a Sony Playstation controller or other controller facilitating the wireless play of video games.

A display 22 is provided and the display 22 has an input port 24. The display 22 may comprise a flat screen television or the like. The input port 24 may comprise a usb port, an HDMI port or other data transmission port.

A storage unit 26 is provided and the storage unit 26 is in selective communication with the electronic device 12. The storage unit 26 receives and stores the data pertaining to the video game. The storage unit 26 is in selective communication with the controller 16. The storage unit 26 is in selective communication with the display 22. The display 22 displays the video game thereby facilitating the video game to be played when the display 22 is in a remote location with respect to the electronic device 12.

The storage unit 26 comprises a housing 28 that has a first end 30 and a second end 32. Indicia 34 may be printed on the housing 28. The indicia 34 may comprise the letters GPPMS. A processor 36 is positioned within the housing 28. The processor 36 may comprise an electronic processor or the like. The processor 36 may additionally comprise a high speed processor associated with video gaming or other high performance applications.

A plug 38 is coupled to the first end 30 and the plug 38 is electrically coupled to the processor 36. The plug 38 is selectively electrically coupled to the output port 14 on the electronic device 12. Thus, storage unit 26 receives the data pertaining to the video game. The plug 38 is selectively electrically coupled to the input port 24 on the display 22. Thus, the display 22 facilitates the video game to be played. The 38 plug may comprise a usb plug, an HDMI plug or other data transmission plug and the plug 38 supplies electrical power to the processor 36.

An electronic memory 40 is positioned within the housing 28 and the electronic memory 40 is electrically coupled to the processor 36. The electronic memory 40 stores the data pertaining to the video game. The electronic memory 40 may comprise RAM memory or the like. The electronic memory 40 may have a storage capacity of at least thirty two gigabytes. A cap 41 is provided and the cap 41 is removably coupled to the first end 30 of the housing 28.

A second transceiver 42 is positioned within the housing 28 and the second transceiver 42 is electrically coupled to the processor 36. The second transceiver 42 is in wireless electrical communication with the first transceiver 20. Thus, the controller 16 may control operational aspects of the video game stored within the electronic memory 40. The second transceiver 42 may comprise a radio frequency transceiver or the like and the second transceiver 42 may utilize a WPAN signal.

The second transceiver 42 may be in wireless electrical communication with an extrinsic communications network 44. The extrinsic communications network 44 may comprise the internet. The second transceiver 42 facilitates the processor 36 to communicate with a remote server 46. The remote server 46 may comprise a Microsoft Xbox server or the like. The processor 36 facilitates an authentication code to be communicated to the remote server 46 thereby facilitating the data stored in the electronic memory 40 to be accessed. The authentication code may comprise a Microsoft Outlook login or the like.

A plurality of light emitters 48 is provided. Each of the light emitters 48 is coupled to the housing 28 and each of the light emitters 48 selectively emits light. Each of the light emitters 48 may be positioned on a top side 49 of the housing 28. Each of the light emitters 48 is electrically coupled to the processor 36. The processor 36 selectively turns each of the light emitters 48 on corresponding to operational parameters of the storage unit 26.

The plurality of light emitters 48 may comprise a controller light emitter 50, a console light emitter 52 and a wifi light emitter 54. The controller light emitter 50 emits light when the second transceiver 42 is in communication with the first transceiver 20. The console light emitter 52 emits light when the processor 36 is in communication with the electronic device 12. The wifi light emitter 54 emits light when the second transceiver 42 is in communication with the extrinsic communications network 44.

In use, the plug 38 is electrically coupled to the output port 14 on the electronic device 12. Data pertaining to a selected video game or video games is downloaded into the electronic memory 40. The plug 38 is removed from the output port 14 and the storage unit 26 is carried to a remote location with respect to the electronic device 12. The plug 38 is electrically coupled to the input port 24 on the display 22 and the display 22 is turned on. The second transceiver 42 is connected to the internet and the authentication code is entered into the remote server 46. The second transceiver 42 is synced with the first transceiver 20 and the controller 16 is manipulated to facilitate video game play.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A portable gaming system comprising:
an electronic device, said electronic device being configured to store data pertaining to a game;
a controller being configured to be manipulated thereby facilitating said controller to control operational aspects of the game;
a display; and
a storage unit being in selective communication with said electronic device wherein said storage unit is configured to receive and store the data pertaining the game, said storage unit being in selective communication with said controller, said storage unit being in selective communication with said display wherein said display is configured to display the game thereby facilitating the game to be played when said display is in a remote location with respect to said electronic device.

2. The system according to claim 1, wherein:
said electronic device has an output port;
said controller has a first transceiver; and
said display has an input port.

3. The system according to claim 1, wherein said storage unit comprises:
a housing having a first end;
a processor being positioned within said housing; and
a plug being coupled to said first end, said plug being electrically coupled to said processor.

4. The system according to claim 3, wherein said plug is selectively coupled to an output port on said electronic device, said plug being in electrical communication with said output port wherein storage unit is configured to receive the data pertaining to the game, said plug being selectively coupled to an input port on said display, said plug being in electrical communication with said input port wherein said display is configured to facilitate the game to be played.

5. The system according to claim 3, further comprising an electronic memory being positioned within said housing, said electronic memory being electrically coupled to said processor wherein said electronic memory is configured to store the data pertaining to the game.

6. The system according to claim 3, further comprising:
a first transceiver; and
a second transceiver being positioned within said housing, said second transceiver being electrically coupled to said processor, said second transceiver being in electrical communication with said first transceiver wherein said controller is configured to control the operational aspects of the game, said second transceiver being configured to be in electrical communication with an extrinsic communications network.

7. The system according to claim 3, further comprising a plurality of light emitters, each of said light emitters being coupled to said housing wherein each of said light emitters is configured to selectively emit light, each of said light emitters being electrically coupled to said processor, said processor selectively turning each of said light emitters on corresponding to operational parameters of said storage unit.

8. A portable gaming system comprising:
an electronic device, said electronic device having an output port, said electronic device being configured to store data pertaining to a game;
a controller being configured to be manipulated thereby facilitating said controller to control operational aspects of the game, said controller having a first transceiver;
a display, said display having an input port; and
a storage unit being in selective communication with said electronic device wherein said storage unit is configured to receive and store the data pertaining the game, said storage unit being in selective communication with said controller, said storage unit being in selective communication with said display wherein said display is configured to display the game thereby facilitating the game to be played when said display is in a remote location with respect to said electronic device, said storage unit comprising:
a housing having a first end,
a processor being positioned within said housing,
a plug being coupled to said first end, said plug being electrically coupled to said processor, said plug being selectively coupled to said output port on said electronic device, said plug being in electrical communication with said output port wherein storage unit is configured to receive the data pertaining to the game, said plug being selectively coupled to said input port on said display, said plug being in electrical communication with said input port wherein said display is configured to facilitate the game to be played,
an electronic memory being positioned within said housing, said electronic memory being electrically coupled to said processor wherein said electronic memory is configured to store the data pertaining to the game,
a second transceiver being positioned within said housing, said second transceiver being electrically coupled to said processor, said second transceiver being in electrical communication with said first transceiver wherein said controller is configured to control the operational aspects of the game, said second transceiver being configured to be in electrical communication with an extrinsic communications network,
a plurality of light emitters, each of said light emitters being coupled to said housing wherein each of said light emitters is configured to selectively emit light, each of said light emitters being electrically coupled to said processor, said processor selectively turning each of said light emitters on corresponding to operational parameters of said storage unit.
